(19) United States
(12) Patent Application Publication
(10) Pub. No.: US 2009/0207144 A1
(43) Pub. Date: Aug. 20, 2009

(54) Position Sensing System With Edge Positioning Enhancement

(75) Inventor: Simon James Bridger, Auckland (NZ)

Correspondence Address: JOHN S. PRATT, ESQ;KILPATRICK STOCKTON, LLP, 1100 PEACHTREE STREET, SUITE 2800, ATLANTA, GA, 30309, US

(73) Assignee: Next Holdings Limited, Auckland City (NZ)

(21) Appl. No.: 12/350,205

(22) Filed: Jan. 7, 2009

Related U.S. Application Data
(60) Provisional application No. 61/019,407, filed on Jan. 7, 2008.

(51) Int. Cl. G06F 3/041

(52) U.S. Cl. 345/173

(57) ABSTRACT

Position sensing systems and methods for enhancing user interaction with an edge of a display. Position sensing components generate signals for determining touch point locations. A distance between the touch point and a nearest edge of the display is calculated. If the distance is not less than a threshold value, a cursor is displayed on the display at a default cursor position closely tracking the touch point. If the distance is less than the threshold value a cursor offset position is calculated and the cursor is displayed at the cursor offset position. The cursor offset position is offset in at least one dimension relative to the default cursor position and may be calculated by applying a geometric transformation to coordinates of the default cursor position. Optionally, the cursor offset position may result in the cursor being “forced” over an item displayed at the edge of the display.

### RELATED APPLICATIONS

This application claims priority to U.S. Provisional Patent Application No. 61/019,407, entitled “Position Sensor With Edge Positioning Enhancement,” which was filed on Jan. 7, 2008.

### TECHNICAL FIELD

The present invention relates generally to position sensing systems, such as touch screens and interactive whiteboards. More particularly, the present invention relates to systems and methods for enhancing user interaction with the edges of a viewing area of display in a position sensing system.

### BACKGROUND OF THE INVENTION

A position sensing system can provide a user interface for allow a user to interact with computer software applications by using a finger, stylus or other pointing device to manipulate a cursor and other displayed items. Position sensing systems can be configured to enable typical cursor-manipulation functions, including “double-click” and “drag-and-drop”. In common practice, a position sensing system will cause a displayed cursor position to closely track the position of the user's pointer.

Many display devices, such as LCD, CRT and plasma displays, include a frame or bezel around the viewing area. In some position sensing systems, position sensing components are embedded in or hidden behind the frame or bezel, possibly increasing the depth or thickness of the frame or bezel. For example, certain optical position sensing systems rely on optical sensors (e.g., CCD or CMOS sensors) and electromagnetic radiation emitters (e.g., infrared or ultraviolet light LED) that are located within or behind a bezel surrounding the viewing area of the display. A frame or bezel can encumber the viewing area of a display and make it physically difficult for a user to interact with items displayed at the edges of the viewing area using a pointer.

In particular, the size of the pointer relative to the bezel and the viewing area can sometimes make it difficult for the user to accurately position a cursor over an item displayed in close proximity to the bezel. For example, most Windows™-based software applications display “close,” “maximize” and “minimize” buttons in the upper right corner of each window. When a window is maximized within the viewing area, these buttons can be displayed at the edge of the display, closely abutting the frame or bezel of the display, and it can be difficult for a user to accurately select among them due to the physical impediment of the frame or bezel. This problem is exacerbated in systems with small display screens and/or high display resolution (i.e., very small icons). In particular the center of a finger cannot be physically positioned above the corner of the viewable area of the screen. In some touch systems the edge of the touch screen is extremely inaccurate, and similar problems arise from the inaccuracy rather than direct mechanical constraints.

Current position sensing systems having frames or bezels are sometimes intentionally “miscalibrated”, to a certain degree, to enable position sensing at the edges of the display area. In other words, such systems are configured to register a “touch” when a cursor is positioned “near enough” to an item displayed at the edge of the display area. However, without the direct feedback of the cursor being positioned over the selected item, the user has no assurance that the item that will be selected by the position sensing system is in fact the item that user intends to select. What is needed, therefore, is a position sensing system with functionality for allowing a user to more accurately manipulate items displayed at the edges of the display area.

### SUMMARY OF THE INVENTION

The present invention provides systems and methods for enhancing user interaction with an edge of a display in a position sensing system. A position sensing system includes a display and at least one position sensing component. The position sensing components generate signals used for determining locations of touch points resulting from a pointer interacting with the display. The position sensing components may be, for example line scan cameras, area scan cameras and/or phototransistors.

The system also includes a computing device for executing instructions stored in at least one associated computer-readable medium for: processing at least one of said signals generated by the position sensing components to calculate the location of a touch point relative to the display; determining a distance between the touch point and a nearest edge of the display; if the distance between the touch point and the nearest edge is not less than a threshold value, displaying a cursor on the display at a default cursor position closely tracking the touch point; and if the distance between the touch point and the nearest edge is less than the threshold value, calculating a cursor offset position and displaying the cursor on the display at the cursor offset position. By way of example, the default cursor position may be substantially near the approximate center of the touch point. The cursor offset position is offset in at least one dimension relative to the default cursor position and may be calculated by applying a geometric transformation, such as a matrix transformation, to the coordinates of the default cursor position. Optionally, the cursor offset position may result in the cursor being “forced” over an item displayed at the edge of the display. The item may be selected, for example heuristically, from a plurality of items displayed at the edge of the display.

These and other aspects and features of the invention will be described further in the detailed description below in connection with the appended drawings and claims.

### BRIEF DESCRIPTION OF THE DRAWINGS

FIG. 1 is an illustration of a position sensing system, in accordance with certain exemplary embodiments of the present invention.

FIG. 2, comprising FIGS. 2A and 2B, is an illustration of a pointer interacting with an exemplary position sensing system, according to certain exemplary embodiments of the present invention.

FIG. 3, comprising FIG. 3A, FIG. 3B, FIG. 3C and FIG. 3D, is an illustration of a pointer interacting with various edges of a display in an exemplary position sensing system, according to certain exemplary embodiments of the present invention.

FIG. 4 is a flow chart illustrating an exemplary edge position enhancement method, in accordance with certain exemplary embodiments of the present invention.

FIG. 5, comprising FIG. 5A and FIG. 5B, illustrates exemplary heuristics that can be used for selection target items nearby a touch point, in accordance with certain exemplary embodiments of the present invention.

### DETAILED DESCRIPTION OF EXEMPLARY EMBODIMENTS OF THE INVENTION

The present invention provides a position sensing system with edge positioning enhancement, which allows a user to more accurately manipulate items displayed at the edges of the viewing area of a display. In a default mode, when the user's pointer is not at or near an edge of the viewing area, a displayed cursor position closely tracks the position of the user's pointer. However, as the pointer approaches an edge of the viewing area, the cursor position is offset from the pointer in a direction toward that edge. In this manner, the cursor may be positioned over items displayed at the edges of the display, even if the pointer is prevented from doing so due to the presence of a surrounding frame or bezel.

The systems and methods of the present invention facilitate the accurate detection of user selection of items displayed at or near an edge of a viewing area of a position sensing system. Consequently, the present invention is well suited for use in devices such as mobile phones, PDAs, gaming equipment, office machinery, interactive whiteboards, and other computing devices that detect user interaction through a position sensing system.

Reference will now be made in detail to various and alternative exemplary embodiments and to the accompanying drawings, with like numerals representing substantially identical structural elements. Each example is provided by way of explanation, and not as a limitation of the scope of invention. It will be apparent to those skilled in the art that modifications and variations can be made without departing from the scope or spirit of the present disclosure and the appended claims. For instance, features illustrated or described as part of one embodiment of the invention may be used in connections with another embodiment to yield a still further embodiment. Thus, it is intended that the present disclosure includes any and all modifications and variations as come within the scope of the appended claims and their equivalents.

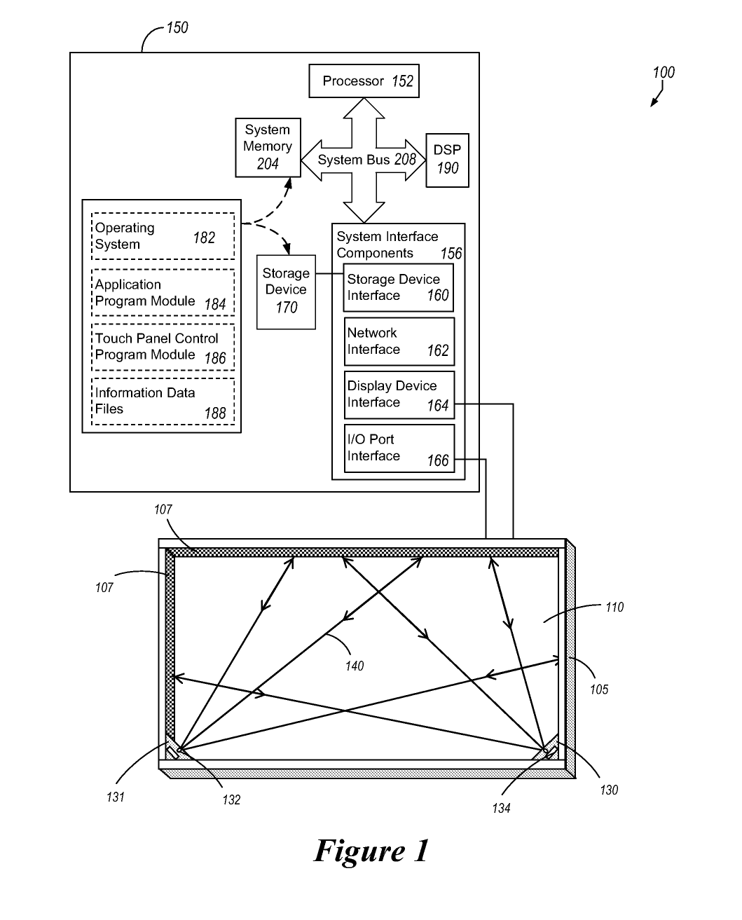

FIG. 1 is an illustration of an exemplary position sensing system, referred to hereinafter as a touch screen system 100. As used herein, the term “touch screen system” is meant to refer to a display 110 and the hardware and/or software components that provide position sensing or touch detection functionality. The exemplary touch screen system 100 includes a display 110 having one or more position sensing components 130, 131 and interfaced to a computing device 150, which executes one or more software modules for detecting a touch point (i.e., sensing the position of a pointer) on or near the display 110. The touch screen system thus enables a user to view and interact with visual output presented on the display 110.

The touch screen system 100 illustrated in FIG. 1 is intended to represent an exemplary optical touch screen system. Those skilled in the art will appreciate, however, that embodiments of the present invention are applicable to any other type of touch screen or interactive whiteboard system, including systems having position sensing components based on resistive, surface capacitive, surface acoustic wave (SAW), infrared (IR), frustrated total internal refraction (FTIR), projected capacitive, and bending wave technologies. Those skilled in the art will also appreciate that some position sensing systems, including optical position sensing systems, do not necessarily require a user to touch the display screen in order to interact with it. Accordingly, use of the term “touch” herein is intended to refer generally to an interaction between a pointer and a display screen and not specifically limited to a contact between the pointer and the display screen.

Optical touch screen systems, like the one illustrated in FIG. 1, rely on a combination of electromagnetic radiation, reflectors (or other light guides), optical sensors, digital signal processing, and algorithms to determine the position of a pointer within a viewing area. For example, as shown, a bezel 105 borders the viewing area of the display screen 110. Position sensing components 130, 131 are positioned in two or more corners of the display 110. Each position sensing component 130, 131 can include an electromagnetic radiation source 132, such as an LED, and an optical sensor 134, such as a line scan or area scan camera. The optical sensors 134 can be based on complementary metal oxide semiconductor (CMOS), charge coupled device (CCD), charge injection device (CID) or phototransistor technologies, or any other sensors capable of detecting changes in electromagnetic radiation. The electromagnetic radiation sources 132 emit electromagnetic radiation 140, such as ultraviolet, visible or infrared light, into the viewing area of the display 110. The electromagnetic radiation 140 is guided throughout the viewing area by reflectors 107 applied to the bezel 105 and/or by refractors or other suitable light guide means. The electromagnetic radiation 140 thus “illuminates” the viewing area of the display 110. A pointer or other object placed within the viewing area disturbs the illumination and creates a shadow effect that can be detected by the optical sensors 134. The position of the shadow, which corresponds to a touch point, can be determined through signal processing and software algorithms, as is well known in the art.

The position sensing components 130, 131 thus transmit data regarding variations in the electromagnetic radiation 140 to a computing device 150 that executes software for processing said data and calculating the location of a touch relative to the display 110. The computing device 150 may be functionally coupled to the display 110 and/or the position sensing components 130, 131 by a hardwire or wireless connection. As mentioned, the computing device 150 may be any type of processor-driven device, such as a personal computer, a laptop computer, a handheld computer, a personal digital assistant (PDA), a digital and/or cellular telephone, a pager, a video game device, etc. These and other types of processor-driven devices will be apparent to those of skill in the art. As used in this discussion, the term “processor” can refer to any type of programmable logic device, including a microprocessor or any other type of similar device.

The computing device 150 may include, for example, a processor 152, a system memory 154 and various system interface components 156. The processor 152, system memory 154 and system interface components 156 may be functionally connected via a system bus 158. The system interface components 156 may enable the processor 152 to communicate with peripheral devices. For example, a storage device interface 160 can provide an interface between the processor 152 and a storage device 170 (e.g., a removable or non-removable disk drive). A network interface 162 may also be provided as an interface between the processor 152 and a network communications device (not shown), so that the computing device 150 can be connected to a network.

A display device interface 164 can provide an interface between the processor 152 and the display 110, which may be a computer monitor, whiteboard or other display device. One or more input/output (“I/O”) port interfaces 166 may be provided as an interface between the processor 152 and various input and/or output devices. For example, the position sensing components 130, 131 may be functionally connected to the computing device 150 via suitable input/output interface(s) 166.

A number of program modules may be stored in the system memory 154 and/or any other computer-readable media associated with the storage device 170 (e.g., a hard disk drive). The program modules may include an operating system 182. The program modules may also include an application program module 184 comprising computer-executable instructions for displaying images or other items on the display 110. Other aspects of the exemplary embodiments of the invention may be embodied in one or more touch screen control program module(s) 186 for controlling the position sensing components 130, 131 of the touch screen system 100 and/or for calculating touch points and cursor positions relative to the display 110.

Certain embodiments of the invention may include a digital signal processing unit (DSP) 190 for performing some or all of the functionality ascribed to the touch screen control program module 186. As is known in the art, a DSP 190 may be configured to perform many types of calculations including filtering, data sampling, and triangulation and may be used to control the modulation of the radiation sources of the position sensing components 130, 131. The DSP 190 may include a series of scanning imagers, digital filters, and comparators implemented in software. The DSP 190 may therefore be programmed for calculating touch points and cursor positions relative to the display 110, as described herein. Those of ordinary skill in the art will understand that the functions of the DSP 190 may also be implemented by other means, such as by the operating system 182, by another driver or program module running on the computerized device 150, or by a dedicated touch screen controller device. These and other means for calculating touch points and cursor positions relative to a display 110 in a touch screen system 100 are contemplated by the present invention.

The processor 152, which may be controlled by the operating system 182, can be configured to execute the computer-executable instructions of the various program modules. The methods of the present invention may be embodied in such computer-executable instructions. Furthermore, the images or other information displayed by the application program module 184 may be stored in one or more data files 188, which may be stored on any computer-readable medium associated with the computing device 150.

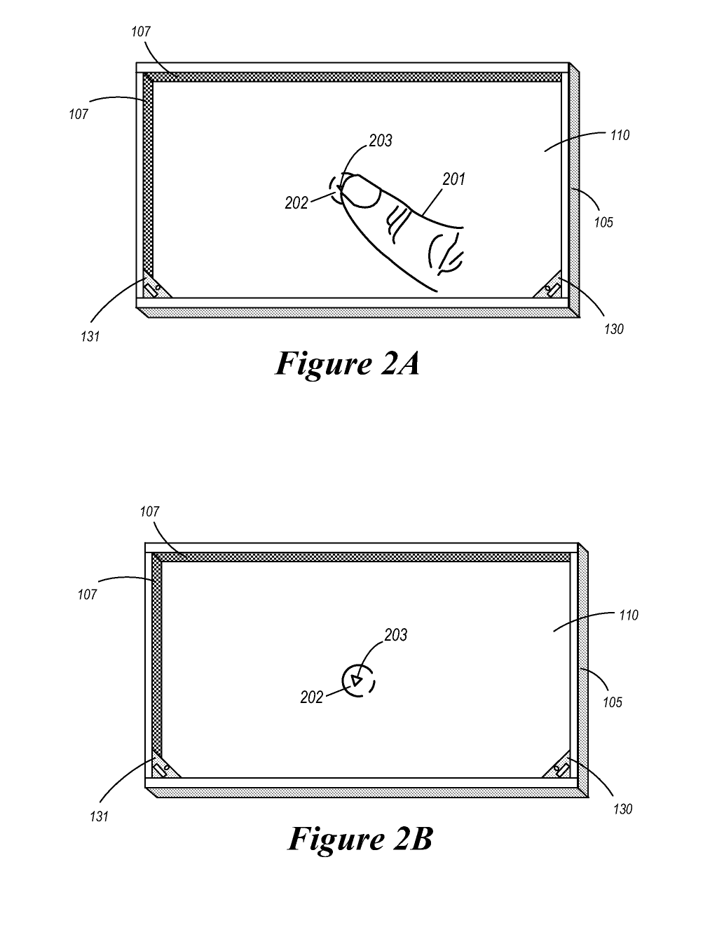

FIG. 2A is an illustration of a pointer 201 interacting with a display 110 of an exemplary touch screen system 100. The pointer 201 may be a finger, stylus or other suitable object. As discussed above, when the pointer 201 touches on or near the display 110, the touch screen system 100 will determine the relative position of the touch (represented as touch point 202). The touch screen system 100 will also determine an appropriate response to the touch, such as to display a cursor 203 in close proximity to the touch point 202. In accordance with the present invention, the touch screen system 100 also includes functionality for determining whether the touch point 202 is near or approaching an edge 112 of the display 110. For example, the touch screen control program module 186 and/or DSP 190 may include logic for calculating coordinates of a touch point 202 and comparing them to coordinates representing the edges 112 of the viewing area of the display 110, to determine if the current touch point 202 is within a configurable distance of at least one of the edges 112. When the touch point 202 is not near or approaching an edge 112 of the display 110, the cursor 203 may be displayed in a default position relative to the touch point 202. For example, the default cursor position may be at or near the approximate center of the touch point 202, as shown in FIG. 2B, or otherwise within a specified distance from the touch point 202.

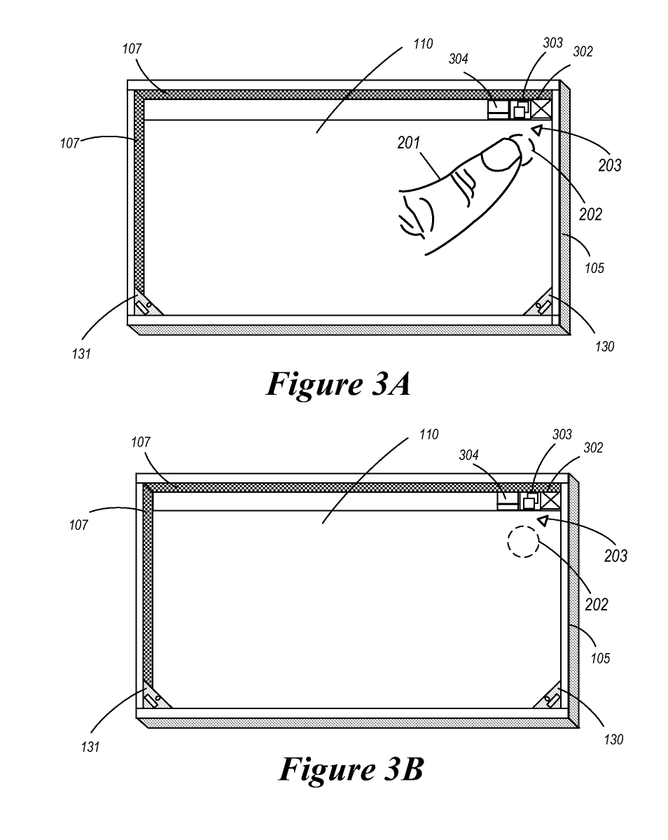

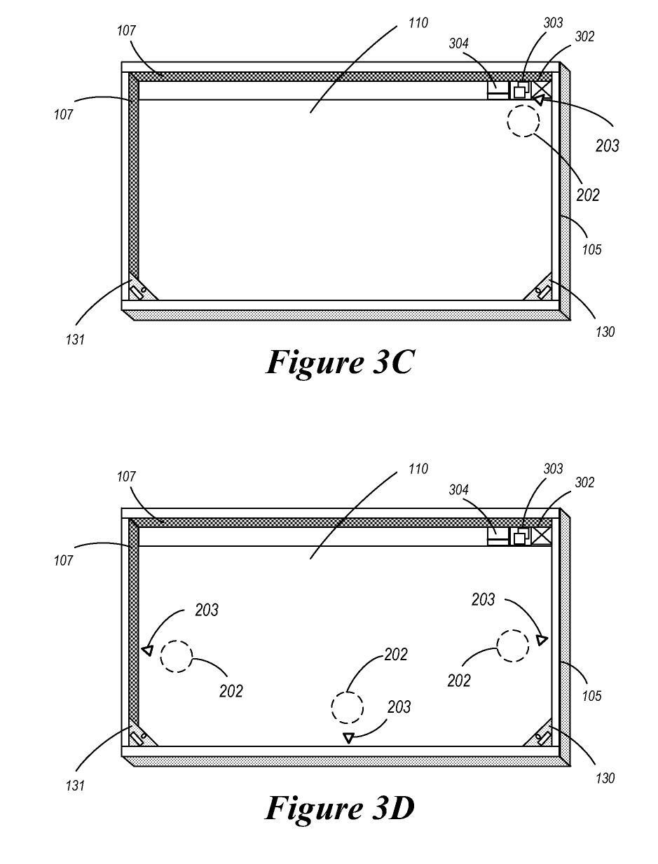

FIG. 3A is an illustration of a pointer 201 approaching an edge 112 of a display 110 in an exemplary touch screen system 100. The touch screen system 100 calculates the touch point 202 and determines that it is at or sufficiently near the edge 112 of the display 110. In this case, rather than display the cursor 203 in its default position, the cursor 203 is displayed in an offset position, as also shown in FIG. 3B. The cursor offset position is offset relative to the default cursor position, thus resulting in the cursor 203 being displayed offset from the touch point 202. The distance and direction of the cursor offset position relative to the default cursor position is determined by the touch screen control program module 186 and/or DSP 190 and/or other suitable components of the touch screen system 100.

In certain embodiments, the cursor offset position is set as a fixed distance from the default cursor position (or touch point 202) in a direction toward the relevant edge 112 of the display 110. In other embodiments, the distance of the cursor offset position from the default cursor position (or touch point 202) may vary with the distance from the default cursor position (or touch point 202) to the edge 112. For example, the distance between the cursor offset position and the default cursor position (or touch point 202) may increase as the pointer 201 approaches the edge 112. In still other embodiments, the speed and/or acceleration of the pointer 201 may influence the calculation of the cursor offset position. In addition, the angular position and movement of the pointer 201 can be factored into the calculation of the cursor offset position. For example the cursor offset position may be calculated relative to the default cursor position (or touch point 202) using a linear or other geometric transformation (e.g., a matrix transformation). So, if the pointer 201 is approaching an edge 112 of the display 110 at a relative angle of 45 degrees, the cursor 201 may be displayed at its offset position also at a relative angle of 45 degrees. In other words, a cursor offset position may involve changes in multiple dimensions relative to the default cursor position (or touch point 202).

As shown in FIG. 3C, in some embodiments, the cursor offset position may be set such that the cursor 203 is forced towards or onto a displayed item 302 (e.g., icon, control, text, or other graphic) in the vicinity of the touch point 202 or the edge 112 approached by the touch point 202. For example, if the touch point 202 is determined to be within a configurable distance (optionally accounting for the speed or acceleration of the pointer 201) of a displayed item 302, the cursor offset position may be calculated such that the cursor 203 is displayed on or over the displayed item. In cases where there are multiple displayed items 302-304 in the vicinity of the touch point 202, the calculation of the cursor offset position may include a heuristic or other algorithm for attempting to discern which displayed item the user desires to manipulate. Based on feedback provided by the user (e.g., indicating a “double-click” or changing the position of the pointer 201), a determination can be made as to whether the correct displayed item was selected. If not, the cursor offset position may be recalculated to force the cursor 201 towards or onto another displayed item (e.g., item 303 or item 304).

Those skilled in the art will recognize that the edge enhancement process of the present invention can be used to calculate cursor offset positions in relation to any edge 112 or corner (i.e., two edges) of a display 110, as shown in FIG. 3D. In still other embodiments, the edge enhancement process of the present invention may be implemented with respect to any other region of interest of a display 110 in addition to or as an alternative to the edge regions. In “multi-touch” position sensing systems capable of detecting more than one simultaneous touch point, the present invention may be used to determine cursor offset positions for one or more of the touch points. In multi-touch scenarios where only one cursor is actually displayed, the other cursor offset positions can be used for selecting or otherwise manipulating items at an edge of the display 110 without displaying another cursor.

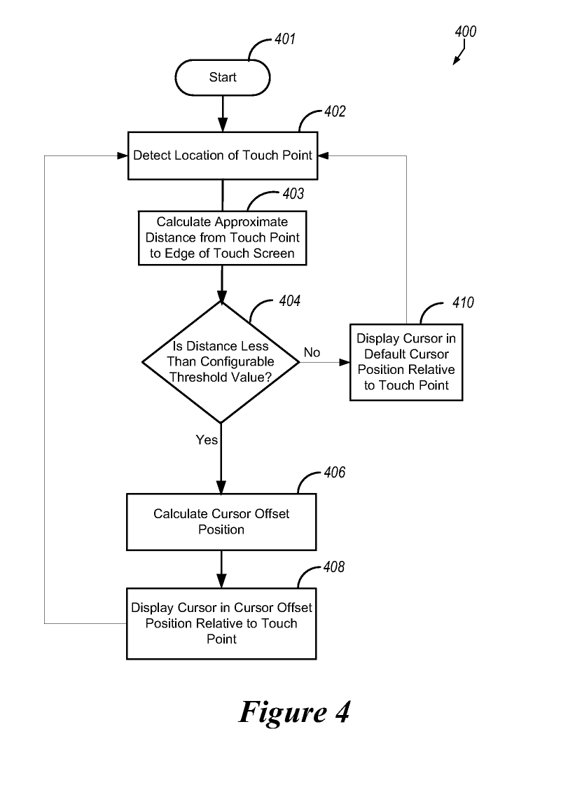

FIG. 4 is a flow chart illustrating an exemplary edge enhancement process 400 in accordance with certain embodiments of the present invention. The edge enhancement process 400 begins at starting block 401 and proceeds to step 402, where the location of a pointer (i.e., touch point 202) relative to the display 110 is determined. The touch point 202 may be determined, for example, by processing information received from one or more position sensing component 130, 131 and performing one or more well-known slope line and/or triangulation calculations. Those skilled in the art will appreciate that other algorithms and functions may also or alternatively be used for calculating the location of the touch point 202, depending on the type of position sensing system employed.

Following step 402, the method proceeds to step 403, where the distance or approximate distance between the touch point 202 and the nearest edge 112 of the display 110 is calculated. For example, this determination may be made by comparing the coordinates of the touch point 202 with known coordinates of the edges of a defined grid representing the viewing area of the display 110. Those skilled in the art will understand that other known methods may be used to calculate the approximate distance from the touch point 202 to the nearest edge 112 of a display 110, in accordance with the present invention.

Once the distance from the touch point 202 to the edge 112 is calculated, the method proceeds to step 404, where a determination is made as to whether the calculated distance is less than a configurable threshold value. By way of illustration (and not limitation), the threshold value may be defined to be approximately 5 mm to approximately 10 mm. Alternatively, the threshold value may be set at any distance that is appropriate given the dimensions and resolution of the display 110, any surrounding frame or bezel 105, the dimensions of the typical pointer 201 used with the touch screen system 100, etc. In certain embodiments, the threshold value may be defined by a user or system administrator upon set-up/calibration of the touch screen system 100. In other embodiments, the threshold value may be selectively changed by a user during operation of the touch screen system 100, for example, using a menu option of a system utility or an application program. In still other embodiments, the threshold value is defined at time of manufacturer of the touch screen system 100 and cannot thereafter be altered by a user or administrator.

If it is determined at step 404 that the distance from the touch point 202 to the nearest edge 112 of the display 110 is not less than the configurable threshold value, the method proceeds to step 410, where an instruction is issued to display the cursor 203 in the default cursor position relative to the touch point 202. Those skilled in the art will appreciate that the instruction described with respect to step 410 may not actually be necessary in certain embodiments. For example, the program module (e.g., operating system 182 or touch panel control program module 186) responsible for displaying the cursor 203 may be configured to use the default cursor position unless an overriding instruction is received. Accordingly, step 410 is shown by way of illustration only. Following step 410, the method returns to step 402 for detection of the next touch point.

If it is determined at step 404 that the distance from the touch point 202 to the nearest edge 112 of the display 110 is less than the configurable threshold value, the method moves to step 406, where a cursor offset position is calculated. As described above, the cursor offset position may be calculated by applying a geometric transformation (e.g., a matrix transformation) to coordinates of the default cursor position (or the coordinates of the touch point 202) or by any other suitable calculation. The cursor offset position may be set such that the cursor 203 is forced towards or onto a particular displayed item 302 in the vicinity of the touch point 202 or the edge 112 approached by the touch point 202, for example using a heuristic or other selection algorithm.

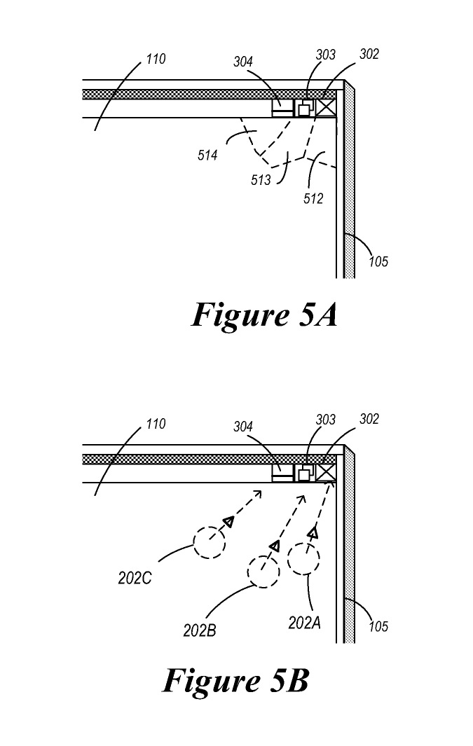

One such heuristic algorithm may involve logically dividing the display 110 into different zones, defined by weighted preferences for the selection of nearby controls or other displayed items. For example, FIG. 5A shows a corner region of a display 110 divided into three logical zones 512, 513 514. The zones were defined according to observed or expected weighted preferences for the selection of nearby controls 302, 303, 304. Accordingly, a touch detected in the first logical zone 512 will be assigned to the “close” control 302, a touch detected in the second logical zone 513 will be assigned to the “maximize” control 303, and a touch detected in the third logical zone 514 will be assigned to the “minimize” control 304. The use of zone weighting can make it easier to correctly identify the user's target control. This is especially true of the “maximize” control 303, that sits tightly between the “close” control 302 and the “minimize” control 304.

As another selection algorithm example, where the touch point 202 is moving, indicating that the user is seeking a control, the trajectory of the touch point 202 may be extrapolated to establish the most likely target control or zone assigned thereto. FIG. 5B illustrates this concept by shown three different touch points 202A, 202B, 202C, each having a different trajectory. As shown, the trajectory of the first touch point 202A can be extrapolated to the “close” control 302, the trajectory of the second touch point 202B can be extrapolated to the “maximize” control 303, and the trajectory of the third touch point 202C can be extrapolated to the “minimize” control 304.

Selection of a target item (to which the cursor 203 may be forced or displayed over) may be done using fuzzy logic to weight different zones of the display, distances from the touch point to nearby items and/or trajectory information. It is envisaged that because the consequences of false prediction of target controls vary, the heuristic may be different for each control. These and other calculations may be performed for determining the cursor offset position, as discussed herein and as will be otherwise apparent to those of ordinary skill in the art. Once the cursor offset position is calculated, the method proceeds to step 408, where an instruction is issued to display the cursor 203 at the cursor offset position. Following step 408, the method returns to step 402 for detection of the next touch point.

The benefits and features of edge enhancement process 400 may not always be useful, for example in applications that do not involve user interaction with an edge 112 of a display 110, or in applications where the pointer 201 is small enough to accurately select items 302-304 along an edge 112 of a display 110 without interference from a bezel or frame 105. In these and other examples, a user may wish to selectively enable or disable the edge enhancement process 400. In one embodiment of the present invention, this function may be controlled using a keyboard combination function, such as the scroll-lock key. The function may also be implemented as a menu selection in an application or utility, or fully implemented in the position sensors 130, 131 of the touch screen system 100. Those of skill in the art will appreciate that the function of selectively enabling the edge enhancement process 400 may be implemented in other ways, each of which is contemplated by embodiments of the present invention.

Based on the foregoing, it can be seen that the present invention provides an improved touch screen system with edge position enhancement. Many other modifications, features and embodiments of the present invention will become evident to those of skill in the art. For example, those skilled in the art will recognize that embodiments of the present invention are useful and applicable to a variety of applications, including, but not limited to, personal computers, office machinery, gaming equipment, and personal handheld devices. Accordingly, it should be understood that the foregoing relates only to certain embodiments of the invention, and are presented by way of example rather than limitation. Numerous changes may be made to the exemplary embodiments described herein without departing from the spirit and scope of the invention as defined by the following claims.

What is claimed is:

1. A method of enhancing user interaction with an edge of a display in a position sensing system, the method comprising:
determining a location of a touch point resulting from a pointer interacting with said display;
determining that the location of the touch point is within a distance from said edge of the display that is less than a threshold value;
calculating a cursor offset position, wherein the cursor offset position is offset in at least one dimension relative to a default cursor position, said default cursor position closely tracking the touch point; and
displaying a cursor on the display at the cursor offset position.

2. The method of claim 1, wherein the default cursor position is substantially near the approximate center of the touch point.

3. The method of claim 1, wherein the cursor offset position is calculated by applying a geometric transformation to coordinates of the default cursor position.

4. The method of claim 3, wherein the geometric transformation comprises a matrix transformation.

5. The method of claim 1, wherein the cursor offset position results in the cursor being displayed over an item displayed at the edge of the display.

6. The method of claim 5, wherein the item is selected from a plurality of items displayed at the edge of the display.

7. The method of claim 6, wherein the item is heuristically selected from the plurality of items.

8. A method of enhancing user interaction with an edge of a display in a position sensing system, the method comprising:
based on signals generated by one or more position sensor, determining a location of a touch point resulting from a pointer interacting with said display;
determining a distance between the touch point and a nearest edge of the display;
if the distance between the touch point and the nearest edge is not less than a threshold value, displaying a cursor on the display at a default cursor position, said default cursor position closely tracking the touch point; and
if the distance between the touch point and the nearest edge is less than the threshold value, calculating a cursor offset position and displaying the cursor on the display at the cursor offset position, said cursor offset position being offset in at least one dimension relative to the default cursor position.

9. The method of claim 8, wherein the default cursor position is substantially near the approximate center of the touch point.

10. The method of claim 8, wherein the cursor offset position is calculated by applying a geometric transformation to coordinates of the default cursor position.

11. The method of claim 10, wherein the geometric transformation comprises a matrix transformation.

12. The method of claim 8, wherein the cursor offset position results in the cursor being displayed over an item displayed at the edge of the display.

13. The method of claim 12, wherein the item is selected from a plurality of items displayed at the edge of the display.

14. The method of claim 12, wherein the item is heuristically selected from the plurality of items.

15. The method of claim 8, wherein the at least one position sensing component is selected from the group consisting of: a line scan camera, an area scan camera and a phototransistor.

16. A position sensing system for enhancing user interaction with an edge of a display, comprising:
a display;
at least one position sensing component for generating signals used for determining locations of touch points resulting from a pointer interacting with said display; and
a computing device for executing instructions stored in at least one a computer-readable medium for:
processing at least one of said signals to calculate the location of a touch point relative to the display,
determining a distance between the touch point and a nearest edge of the display,
if the distance between the touch point and the nearest edge is not less than a threshold value, displaying a cursor on the display at a default cursor position, said default cursor position closely tracking the touch point; and
if the distance between the touch point and the nearest edge is less than the threshold value, calculating a cursor offset position and displaying the cursor on the display at the cursor offset position, said cursor offset position being offset in at least one dimension relative to the default cursor position.

17. The position sensing system of claim 16, wherein the default cursor position is substantially near the approximate center of the touch point.

18. The position sensing system of claim 16, wherein the cursor offset position is calculated by applying a geometric transformation to coordinates of the default cursor position.

19. The position sensing system of claim 18, wherein the geometric transformation comprises a matrix transformation.

20. The position sensing system of claim 16, wherein the cursor offset position results in the cursor being displayed over an item displayed at the edge of the display.

21. The position sensing system of claim 20, wherein the item is selected from a plurality of items displayed at the edge of the display.

22. The position sensing system of claim 21, wherein the item is heuristically selected from the plurality of items.

23. The position sensing system of claim 22, wherein the item is selected by a weighted combination of zones and dynamic trajectory information.

24. The position sensing system of claim 16, wherein the at least one position sensing component is selected from the group consisting of: a line scan camera, an area scan camera and a phototransistor.
